(19) United States
(12) Patent Application Publication
(10) Pub. No.: US 2015/0180627 A1
(43) Pub. Date: Jun. 25, 2015

(54) RESOURCE SCHEDULING FOR DOWNLINK TRANSMISSIONS

(71) Applicant: TELEFONAKTIEBOLAGET L M ERICSSON (PUBL), Stockholm (SE)

(72) Inventors: Sairamesh Nammi, Stockholm (SE); Mark Curran, Tullow (IE); Namir Lidian, Solna (SE)

(73) Assignee: TELEFONAKTIEBOLAGET L M ERICSSON (PUBL), Stockholm (SE)

(21) Appl. No.: 14/238,778

(22) PCT Filed: Jan. 15, 2014
(86) PCT No.: PCT/SE2014/050036

§ 371 Date: Feb. 13, 2014

Related U.S. Application Data
(60) Provisional application No. 61/753,569, filed on Jan. 17, 2013.

(51) Int. Cl. H04L 5/00; H04W 72/12

(52) U.S. Cl. CPC H04L 5/0048; H04W 72/12

(57) ABSTRACT

A method performed in a network node, of scheduling resources for downlink transmissions to a user equipment, UE, in a heterogeneous wireless communication network including macro nodes and Low Power Nodes, LPNs, in a combined cell deployment, wherein each macro node shares a cell identity with one or more LPNs. The method comprises configuring two or more pilot signals for probing the UE, wherein each pilot signal is configured to be distinguishable from configured one or more other pilot signals. A resource control, RRC, signal is sent to the UE, the RRC signal including information on the configuration of the two or more pilot signals. The network node controls transmission of the two or more pilot signals, wherein transmission of one pilot signal is originated from the macro node and transmission of one or more further pilot signals is originated from respective one or more LPNs.

### TECHNICAL FIELD

The present disclosure relates to a method performed in a network node for scheduling resources for downlink transmissions to a user equipment, UE, in a heterogeneous wireless communication network. In particular, the disclosure relates to transmission node selection in a heterogeneous network. The disclosure also relates to a network node.

### BACKGROUND

During the last few years cellular operators have started to offer mobile broadband based on WCDMA/HSPA. Further, fuelled by new devices designed for data applications, the end user performance requirements are steadily increasing. The large uptake of mobile broadband has resulted in that the traffic volume that needs to be handled by the HSPA networks has grown significantly. Therefore, techniques that allow cellular operators to manage their network more efficiently are of more and more important.

A first step to improved downlink performance would be to introduce support for 4-branch MIMO, multiflow communication, multi carrier deployment etc. However, since the spectral efficiency per link is approaching theoretical limits, the next step is about improving the spectral efficiency per unit area. In other words, additional features for HSDPA need to provide a uniform user experience anywhere inside a cell by changing the topology of traditional networks. Currently 3GPP is working on this aspect using heterogeneous networks, see for example RP-121436, “Study on UMTS Heterogeneous Networks”; R1-124512, “Initial considerations on Heterogeneous Networks for UMTS”, Ericsson, ST-Ericsson and R1-124513, “Heterogeneous Network Deployment Scenarios”, Ericsson, ST-Ericsson.

A homogeneous network is a network of macro base stations (Node B) in a planned layout and a collection of user terminals in which all base stations have similar transmit power levels, antenna patterns, receiver noise floors, and similar backhaul connectivity to the data network. Moreover, all base stations offer unrestricted access to user terminals in the network, and serve roughly the same number of user terminals. Current wireless system comes under this category for example GSM, WCDMA, HSDPA, LTE, Wimax, etc.

In heterogeneous networks, in addition to the planned or regular placement of macro base stations, several micro/pico/femto/relay/RRU nodes (commonly referred to as Low Power Nodes, LPNs) are deployed as shown in FIG. 1. Note that the power transmitted by these LPNs is relatively small compared to that of macro base stations, e.g. 2W as compared 40W for a typical macro base station. The LPNs are deployed to eliminate coverage holes in the homogeneous networks (using macro only) and to off-load the macro, thereby improving the capacity in hot-spot scenarios. Due to the lower transmit power and smaller physical size a LPN can offer flexible site acquisitions.

Deployed LPNs in a heterogeneous network can have the following properties:
Each LPN has its own cell identity (scrambling code). LPNs and Macros are different cells but they typically share the same frequency—referred to as co-channel deployment.
The LPNs have the same cell identities as the Macro Cell—referred to as soft or combined cell.

One disadvantage with the co-channel deployment is that each LPN creates a different cell, hence a UE need to do soft handover when moving from one LPN to macro or to another LPN. Hence higher layer signaling is needed to perform handover. FIG. 2 shows the Heterogeneous network where LPNs create different cells. Simulations show that using LPNs in a macro cell offers load balancing, hence the huge gains in system throughout as well as cell edge user throughput.

FIG. 3 shows a heterogeneous network where LPNs are part of the macro cell, i.e. a combined cell. A combined cell can be viewed as a distributed antenna system, and is beneficial in many ways. For example, one transmission antenna can be set up at Macro (main unit), while two other antennas can be installed as LPNs (RRUs) at other locations, where each LPN correspond to one or more antenna heads (with its own or potentially shared power amplifier). Communication between different nodes can employ a fast backhaul and a fast communication link (e.g. fiber or mini-link) with the main unit (typically the macro) that is in control of the LPNs; see also FIG. 4. This has many advantages, such as reduced soft handover, as well as energy savings and reduced interference provided by better co-ordination between nodes.

However, transmitting the same symbols through all the nodes in a combined cell causes waste of resources, as well as interference to out of cell users and also in-cell users.

### SUMMARY

The present disclosure relates in general to scheduling of resources for downlink transmissions in a heterogeneous wireless communication network and in particular to selection of transmission nodes in a combined cell in a heterogeneous network. It is an object of the present disclosure to provide a method, a user equipment and a network node for selection of nodes to be used for downlink, DL, transmission in a heterogeneous network with combined cell deployment.

The present disclosure presents a method, performed in a network node, of scheduling resources for downlink transmissions to a user equipment, UE, in a heterogeneous wireless communication network including macro nodes and Low Power Nodes, LPNs, in a combined cell deployment, wherein each macro node shares a cell identity with one or more LPNs. The method comprises configuring two or more pilot signals for probing the UE, wherein each pilot signal is configured to be distinguishable from configured one or more other pilot signals. A radio resource control, RRC, signal is sent to the UE, the RRC signal including information on the configuration of the two or more pilot signals. The network node controls transmission of the two or more pilot signals, wherein transmission of one pilot signal is originated from the macro node and transmission of one or more further pilot signals is originated from respective one or more LPNs. A feedback signal is received, wherein the feedback signal is based on channel information obtained by the UE for each pilot signal. One or more LPNs are selected for downlink transmission based on received feedback signal and UE specific information accessible in the network node.

The disclosed method provides optimized resource utilization. Downlink transmission from all LPNs in a combined cell deployment will in many cases cause waste of resources as well as interference to out of cell users. The ability to enable transmission only from a selection of LPNs that provides clear benefits in a combined cell transmission scenario, significantly improves the resource utilization.

According to an aspect of the disclosure, the selection of downlink resource is initiated when a plurality of LPNs share a cell identity with a macro node.

The disclosure provides a method particularly suitable for a situation with multiple LPNs within the coverage area of a macro node and sharing a cell identity with the macro node in that the method enables optimized selection of a subset of LPNs for a specific UE.

According to another aspect of the disclosure, the selection of downlink resources is initiated when presence of one or more UEs capable of combined cell deployment is detected in a macro cell.

According to a further aspect, the selection of downlink resources for the selected UE follows on a selection of the one or more UEs capable of combined cell deployment and present in the macro cell.

According to a further aspect of the disclosure, each respective UE, of the one or more UEs capable of combined cell deployment present in the macro cell, is selected and the selecting of downlink resources is performed for each selected respective UE.

Detection of one or more UEs capable of combined cell deployment in the macro cell, offers the advantage that the method is performed only when there is a possibility to benefit from the result of the method.

According to an aspect of the disclosure, the step of configuring two or more pilot signals further comprises power scaling the two or more pilot signals so that the power ratio between a pilot signal of the macro node and a pilot signal of the LPN corresponds to a power ratio of a macro node power level and a LPN power level.

The receiving UE determines channel strengths based on received pilot signals. Power scaling of the probing signals in accordance with a power ratio representative of the power ratio of the macro node power level and a LPN power level provides for a feedback signal including channel quality measures that more accurately reflects a contribution from each transmitting node.

The present disclosure also relates to a network node for selecting downlink resources for downlink transmission to a user equipment, UE, in a heterogeneous wireless communication network including macro nodes and Low Power Nodes, LPNs, in a combined cell deployment, wherein each macro node shares a cell identity with one or more LPNs. The network node comprises a processing unit arranged to configure two or more pilot signals for probing the UE, wherein each pilot signal is configured to be distinguishable from configured one or more other pilot signals, and to control transmission of the two or more pilot signals from respective radio access nodes, wherein transmission of one pilot signal is originated from the macro node and transmission of one or more further pilot signals is originated from respective one or more LPNs. A radio communication interface of the network node is configured to send a radio resource control, RRC, signal to the UE including information on the configuration of the two or more pilot signals. The radio communication interface is further configured to receive at least one feedback signal from the UE, wherein the feedback signal is based on channel information obtained by the UE. The processor is further configured to select one or more LPNs for downlink transmission based on received feedback signal and UE specific information accessible in the network node.

The present disclosure also presents a computer program, comprising computer readable code which, when run in a network node causes the network node to perform the disclosed method.

The network node and computer program run in a network node each display advantages corresponding to the advantages already described in relation to the method performed in a network node.

The present disclosure also relates to a method in a user equipment, UE, for assisting selection of downlink resources for downlink transmission in a heterogeneous wireless communication network including macro nodes and LPNs in a combined cell deployment, wherein each macro node shares a cell identity with one or more LPNs. The method comprises receiving a radio resource control, RRC, signal including information on a respective configuration of two or more pilot signals and receiving the two or more pilot signals. The two or more pilot signals are processed to determine channel information for each pilot signal. At least one feedback signal is generated for each pilot signal based on determined channel information. The at least one feedback signal for each pilot signal is transmitted to a receiving macro node.

The disclosed method provides the advantage of optimized resource utilization based on UE feedback. Downlink transmission from all LPNs in a combined cell deployment will in many cases cause waste of resources as well as interference to out of cell users. The ability to base a selection of LPNs on feedback from a receiving UE, significantly improves the resource utilization in a combined cell deployment.

According to an aspect of the disclosure, the processing of the two or more pilot signals includes defining (S831) precoding vectors representing the number of pilot signals. A channel information matrix is estimated based on the received pilot signals and a SINR value is computed for each node from a combination of the precoding vectors and the channel matrix.

The computing of the SINR value enables selection of a modulation and coding scheme in accordance with existing lookup tables based on a SNR; the SNR corresponding to the computed SINR value.

The present disclosure also presents a user equipment, UE, for selecting downlink resources for downlink transmission in a heterogeneous wireless communication network including macro nodes and Low Power Nodes, LPNs, in a combined cell deployment, wherein each macro node shares a cell identity with one or more LPNs. The UE comprises a radio communication interface configured to receive downlink transmissions in the heterogeneous wireless communication network comprising a radio resource control, RRC, signal including information on a respective configuration of two or more pilot signals and the two or more pilot signals; and a processing unit configured to process the received two or more pilot signals to determine channel information for each pilot signal and to generate at least one feedback signal for the received pilot signals based on determined channel information; the radio communication interface further configured to transmit the at least one feedback signal to a receiving macro node.

The present disclosure also presents a computer program, comprising computer readable code which, when run in a user equipment, UE, causes the UE to perform the disclosed method.

The user equipment and computer program each display advantages corresponding to the advantages already described in relation to the method performed in a user equipment.

### BRIEF DESCRIPTION OF THE DRAWINGS

FIG. 1 Illustrates a heterogeneous network

FIG. 2 Illustrates a heterogeneous network with co-channel deployment

FIG. 3 Illustrates a heterogeneous network with combined cell deployment

FIG. 4 Illustrates spatial reuse in a combined cell between two nodes

FIG. 5 Illustrates a typical configuration of a combined cell deployment

FIG. 6 Illustrates a feedback signal from a UE

FIG. 7 is a flow chart illustrating embodiments of method steps in a network node

FIG. 8
a. is a flow chart illustrating embodiments of method steps in a user equipment, UE
b. is a flow chart detailing embodiments of method steps for processing two or more probing signals

FIG. 9 is a block diagram illustrating embodiments of a network node

FIG. 10 is a block diagram illustrating embodiments of a user equipment, UE

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor, DSP, hardware, a reduced instruction set processor, hardware (e.g., digital or analog) circuitry including but not limited to application specific integrated circuits, ASIC, and/or field programmable gate array(s), FPGA, and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the description is given for user equipment, UE, it should be understood by the person skilled in the art that UE is a non-limiting term comprising any wireless device or node equipped with a radio interface allowing for at least one of: transmitting signals in the uplink, UL, and receiving and/or measuring signals in the downlink, DL. Some examples of UE in its most general sense are a PDA, laptop, mobile, sensor, fixed relay, mobile relay, and a radio network node, e.g. a small base station using the terminal technology.

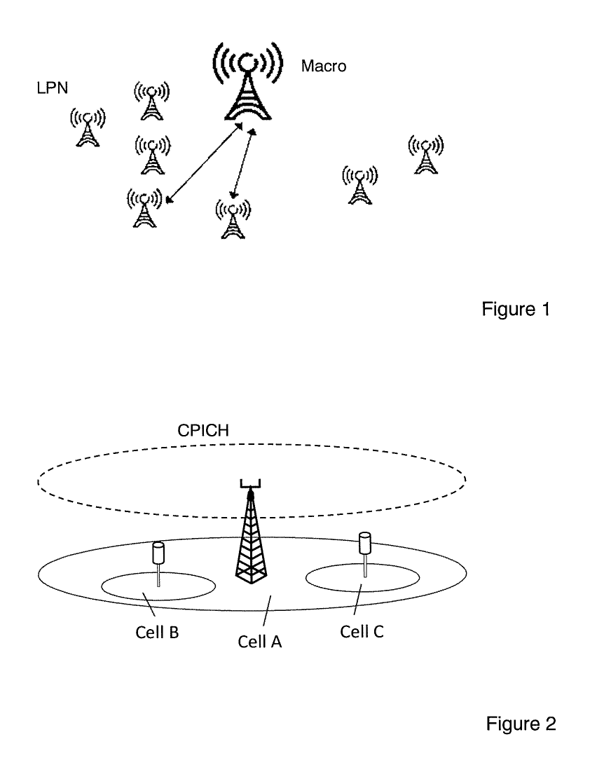

FIG. 1 illustrates a heterogeneous network. In heterogeneous networks, in addition to the planned or regular placement of macro base stations, several micro/pico/femto/relay/RRU nodes (commonly referred to as Low Power Nodes (LPN)) are deployed. The power transmitted by these LPNs is relatively small compared to that of macro base stations. The LPNs may be employed to eliminate coverage holes in the homogeneous networks and to off-load a macro network, thereby improving capacity in e.g. hot-spot scenarios.

FIG. 2 illustrates a heterogeneous network with co-channel deployment. In a co-channel deployment each LPN has its own cell identity (scrambling code). The LPNs and macro nodes define different cells, but typically share the same frequency. Since each LPN represents a specific cell with its own cell identity, a UE needs to do soft handover when moving from one LPN, e.g. Cell B, to macro node, Cell A, or to another LPN, Cell C. Simulations show that heterogeneous network where LPNs create different cells offers load balancing and significant gains in system throughput. However, the co-channel deployment also provides the draw-back of increased signaling in order to enable soft handover between LPNs or from a LPN to a macro node.

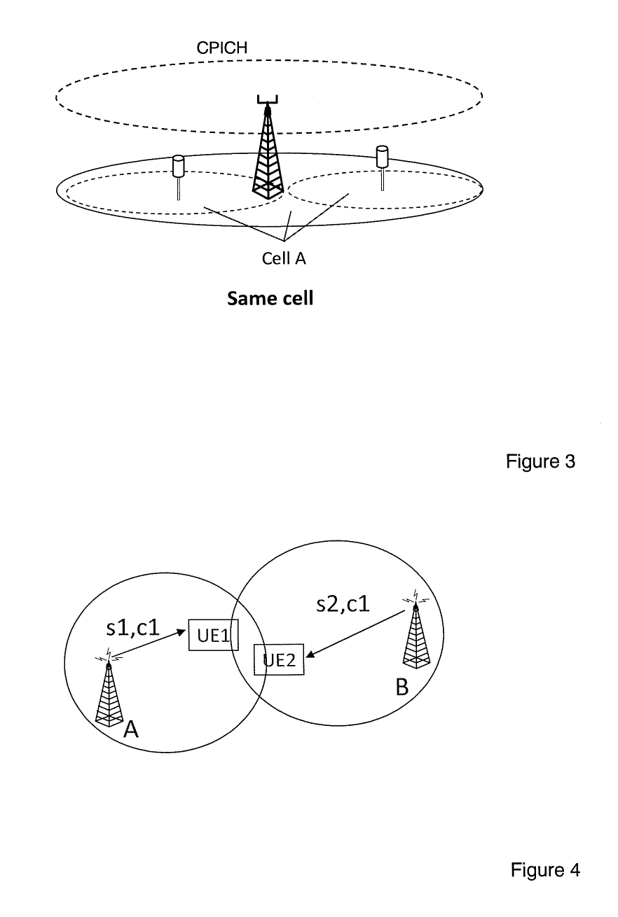

FIG. 3 illustrates a heterogeneous network with combined cell deployment, i.e. where the LPNs have the same cell identities, Cell A, as the macro cell, Cell A, i.e. is part of the macro cell. A combined cell offers the advantage of increased throughput as well as reduced soft handover, energy savings and reduced interference.

FIG. 4 illustrates spatial reuse in a combined cell between two nodes. The combined cell deployment can be viewed as a distributed antenna system where each LPN correspond to one or more antenna heads, with its own or potentially shared power amplifier. Each LPN has a fast communication link with the macro node that is in control of the LPNs. FIG. 4 shows the configuration of spatial reuse in a combined cell between two nodes A, B. The two nodes use the same scrambling codes, c1, but different S-CPICH signals, S-CPICH1 and S-CPICH2 with different spreading codes s1 and s2.

FIG. 5 illustrates a typical configuration of a combined cell deployment wherein a central controller 50, e.g., the macro node, in the combined cell takes responsibility for collecting operation statistics information of network environment measurements. The decision on which nodes 50, 51a, 51b that should be scheduled to transmit to a specific UE is made by the central controller, either on its own or based on the information provided by the UE. The central controller 50 handles the cooperation among the various nodes 50, 51a, 51b.

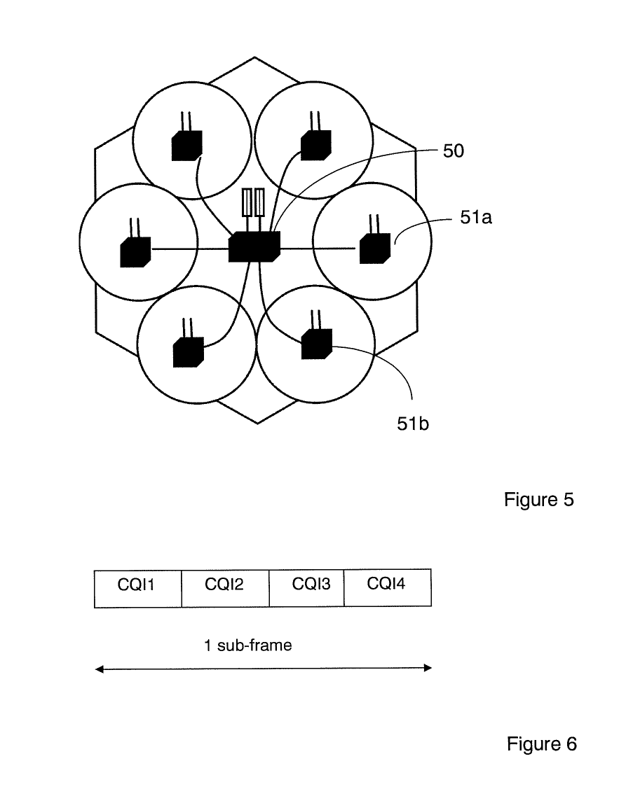

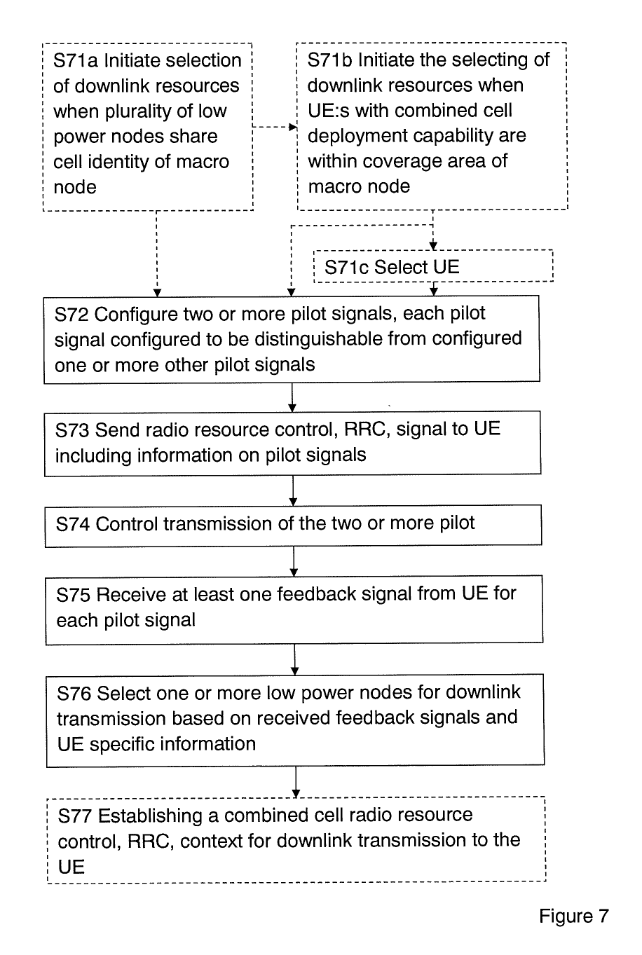

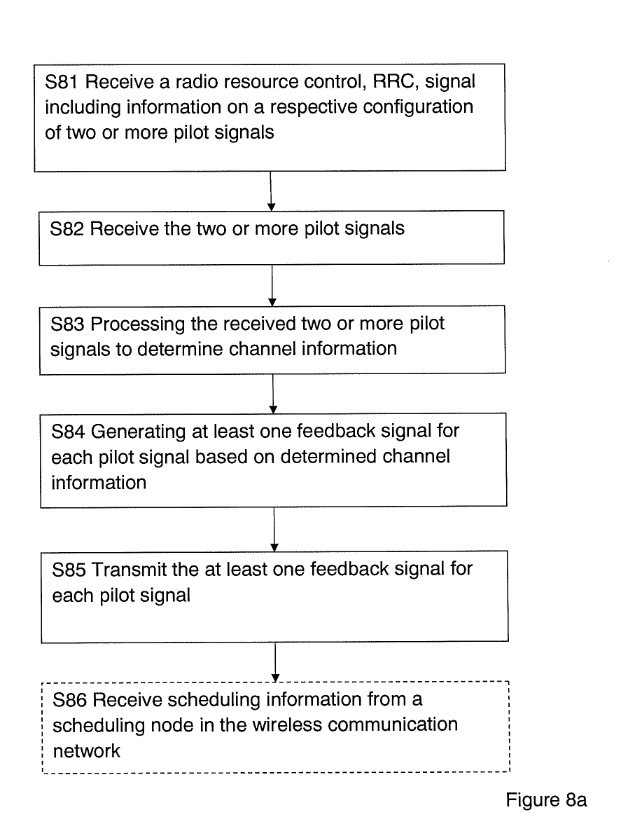

FIG. 6 illustrates a feedback signal from a UE according to one example embodiment. The feedback signal is generated in response to receipt of pilots signals transmitted from the network nodes configured to transmit the pilot signals, e.g a macro node and at least one LPN. Further details of the steps performed in a network node for generating pilot signals will be discussed below with reference to FIG. 7 and details of the steps performed in a UE for generating a feedback signal is discussed below with reference to FIGS. 8a and 8b.

FIG. 7 is a flow chart illustrating embodiments of method steps in a network node operative in a wireless communication network including macro nodes and LPNs in a combined cell deployment, wherein each macro node shares a cell identity with one or more LPNs. The network node is a macro node of the combined cell deployment or any other central controller node.

In a first step S72, the network node configures pilot signals for probing the UE, wherein each pilot signal is configured to be distinguishable from configured one or more other pilot signals. A radio resource control, RRC, signal is sent S73 to the UE from the network node including information on the configuration of the two or more pilot signals.

In accordance with aspects of the disclosure the information on the configuration of the two or more pilot signals is included in an RRC configuration message. The RRC signal includes the pilot configuration, pilot signal values, pilot signal spreading factors, probing periods etc. In a scenario where there is one LPN, the network node configures two pilot signals, one for the macro node and one for the LPN. In a scenario with a plurality of LPNs, the network node configures a plurality of pilot signals wherein one pilot signal is to be sent from the macro node and remaining pilot signals from the plurality of LPNs; thus, for two LPNs and one macro node, the RRC configures three probing pilots and for the situation with three LPNs and one macro node, the RRC configures four probing pilots. According to an aspect, the configured pilot signals are orthogonal. In accordance with an aspect of the disclosure, the pilot signals are transmitted as S-CPICH signals with respective separate spreading codes.

The network node configuring the pilot signals is arranged for node to node communication with the LPNs over a communication interface. The network node, e.g. the macro node, controls, in step S74, transmission of the two or more pilot signals, wherein controlling transmission implies causing transmission of a pilot signal from a pilot signal transmitting node. When the network node is also a macro node, the macro nodes transmits a first configured pilot signal. One or more further pilot signals configured for transmission from LPNs are communicated to the respective LPNs, e.g, by transmitting information on a configuration of the respective pilot signals. A LPN receiving a pilot signal or information on the configuration of a pilot signal, transmits the pilot signal in the radio communication interface. For each pilot signal transmitted from the nodes of the combined cell, a feedback signal is received, in step S75, in the network node from a UE receiving the pilot signals. The feedback signal is based on channel information obtained by a receiving UE, i.e. the UE for which the node selection is performed.

In accordance with an aspect of the disclosure, the UE computes a feedback signal comprising signal quality measures for each node. Such signal quality measures comprises signal to interference noise ratio, SINR, values; signal to noise ratio, SNR, values; and any other foreseeable type of signal quality measures.

FIG. 6 illustrates a feedback signal from a UE, according to one example. The feedback signal is generated in response to receipt of pilots signals transmitted from the network nodes configured to transmit the pilot signals, e.g a macro node and in the illustrated scenario three LPNs.

The feedback signal is processed within the receiving network node that selects, in step S76, one or more LPNs for downlink transmission based on received feedback signal and UE specific information accessible in the macro node. The selecting includes selecting a LPN having a SINR value superior to other SINR values representing other LPNs in the feedback signal.

Based on the selection, the network node sends scheduling information to the UE, e.g. by establishing and using a combined cell radio resource control, RRC, context for the downlink transmission to the UE in step S77. The establishing of the RRC context includes sending information to the selected LPN on the UE connection, i.e. scheduling information. The location of the UE is an example of UE specific information taken into account when performing the selection of one or more LPNs for downlink transmission. However, the disclosure is not limited to considerations relating to a location of the UE when selecting LPNs.

As further disclosed in FIG. 7, there are a variety of triggering mechanisms contemplated for initiating the selection of LPNs. In accordance with a first aspect of the disclosure, the selection of downlink resources is initiated in step 571a when a plurality of LPNs shares a cell identity with a macro node. However, the selection of downlink resources the disclosure also foresees initiation in step S71b, wherein presence of one or more UEs capable of combined cell deployment is detected within a coverage area of a macro node, i.e. a macro cell. This step is either subsequent to a realization that there is a plurality of LPNs sharing the cell identity of a macro node, as disclosed in step S71a, or an independent first step.

In a combined cell scenario where there is a plurality of UEs present in the combined cell, i.e. the macro cell, an initiating step S71c comprises selecting a specific UE for the LPN selecting. A plurality of UEs may also be selected, but selecting of downlink resources in accordance with the disclosed method is then performed for each respective UE. It is a basic concept of the disclosure that one or more best LPNs are selected to a specific UE.

The macro node and LPNs within the coverage are of the macro node have different power levels. According to an aspect of the disclosure, the two or more pilot signals configured in step S72, are configured to in accordance with a power scaling ratio corresponding to a power ratio of a macro node power level and a LPN power level. Thus, even though the macro node and the LPNs have different power levels, the power of the pilot signals is equal in linear scale.

In accordance with a further aspect of the disclosure, information on LPNs not selected for the downlink transmission to the UE is shared among the nodes of the wireless network, providing for improved resource utilization, e.g. through spatial reuse. The scheduling network node then instructs other nodes not transmitting to the specific UE to transmit to other UEs on the same codes.

FIG. 8a is a flow chart illustrating embodiments of method steps in a user equipment, UE being connected to a network node and operative in a wireless communication network including macro nodes and LPNs in a combined cell deployment.

In a first step S81, the UE receives a radio resource control, RRC, signal from a network node, including information on a respective configuration of two or more pilot signals. Consequently, in a subsequent step S82, the UE receives the two or more pilot signals transmitted from the respective macro nodes and LPNs in the combined cell deployment.

The UE processes the received two or more pilot signals to determine channel information corresponding to channel between the UE and a respective macro node or LPN transmitting the pilot signal, in step S83. A feedback signal, e.g. as illustrated in FIG. 6, is generated in step S84, for each pilot signal based on determined channel information. Hence, the feedback signal comprises channel information of a channel between the UE and each macro node or low power node. The feedback sent by the UE, could also include a combination of feedback for each pilot signal in one common feedback signal, including distinct channel quality information for each received pilot signal. Consequently, generating and transmitting, in step S85, at least one feedback signal for each pilot signal, implies that the report sent from the UE to the receiving network node includes information relevant for receipt of a pilot signal from a specific node.

Following reporting of the feedback signal to the receiving network node, the UE awaits scheduling information from the network node. Following receipt of such scheduling information in step S86, the UE is able to receive downlink transmissions from a macro node and one or more LPNs in a combined cell deployment.

According to an aspect, the processing of the two or more pilot signals in the UE includes defining S831 precoding vectors representing the number of pilot signals, estimating S832 a channel information matrix based on received pilot signals; and computing S834 a SINR value for each node from a combination of the precoding vectors and the channel matrix.

The processing and computing of signal quality is, according to one aspect of the disclosure, based on the following algorithm:
a. The precoding coding book is defined as
   P1=[1;0]; P2=[0;1] are the probing precoding vectors if the RRC configures 2 nodes,
   P1=[1;0;0]; P2=[0;1;0]; P3=[0;0;1] are the probing precoding vectors if the RRC configures 3 nodes, and
   P1=[1;0;0;0]; P2=[0;1;0;0]; P3=[0; 0;1;0]; P4=[0;0;0;1] are the probing precoding vectors if the RRC configures 4 nodes. And so on.
b. A channel matrix is estimated using the known symbols from the pilots.
c. A SINR for each entity is computed by multiplying the channel matrix with the probing precoding vector defined in the Step a.
d. With the corresponding SNR, Link adaptation is performed to choose the modulation and coding scheme suitable for this SNR (by lookup tables) for example Table 7 a-J in 3GPP TS 25.214, version 11.2.

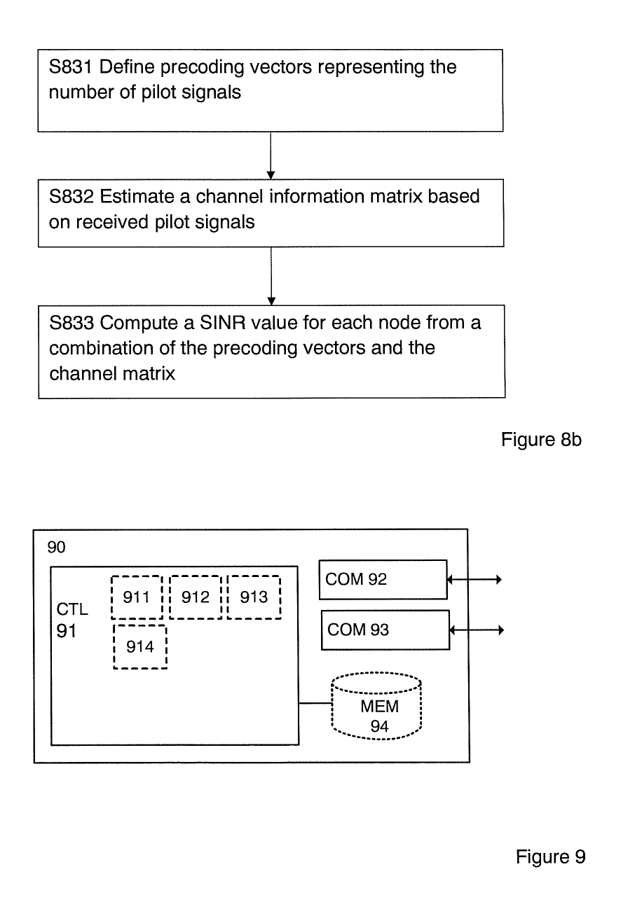

FIG. 9 is a block diagram illustrating an exemplary embodiment of a network node 90, e.g. a macro node. In this application the term network node is generally used. A network node is any type of node having a radio resource scheduling capacity in a wireless communication network e.g. a RBS or an eNodeB.

The network node 90 comprises a controller 91, CTL, or a processing circuitry that may be constituted by any suitable Central Processing Unit, CPU, microcontroller, Digital Signal Processor, DSP, etc. capable of executing computer program code. The computer program may be stored in a memory, MEM 94. The memory 94 can be any combination of a Read And write Memory, RAM, and a Read Only Memory, ROM. The memory 94 may also comprise persistent storage, which, for example, can be any single one or combination of magnetic memory, optical memory, or solid state memory or even remotely mounted memory.

The network node 90 further comprises a radio communication interface, 92. The radio communication interface 92 is arranged for wireless communication with user equipment within a coverage area of the network node. The radio communication interface may be adapted to communicate over one or several radio access technologies.

The network node 90 further comprises a network communication interface, 93. The network communication interface 93 is typically one or more fast communication links, e.g fibre or mini-link, to connected LPNs.

According to one aspect of the disclosure the controller comprises one or several of:
a pilot signal configuration module 911, arranged to configure one or more pilot signals to be transmitted from the macro node and LPNs communicatively connected to the network node by means of the node communication interface 93;
a pilot signal transmission controlling module 912, configured to control transmission from the network node and one or more LPNs communicatively connected to the network node by means of the node communication interface 93;
a feedback signal receiver module 913 configured to receive a feedback signal from a user equipment, UE, within a coverage area of the network node; and
a selecting module 914 configured to select one or more LPNs for downlink transmissions to a receiving UE.

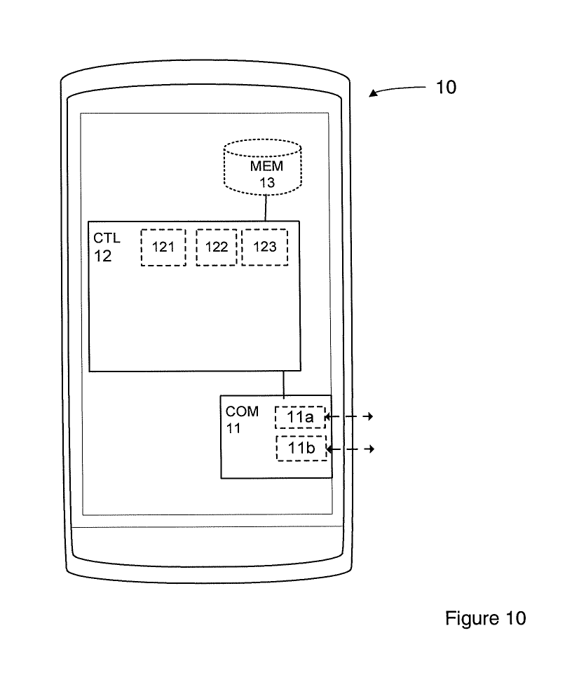

Turning now to FIG. 10, a schematic diagram illustrating some modules of an exemplary embodiment of a user equipment 10. In this application the term user equipment 10 is any wireless device able capable of combined cell deployment in a wireless network.

The wireless device 10 comprises a controller, CTL, or a processing circuitry 12 that may be constituted by any suitable Central Processing Unit, CPU, microcontroller, Digital Signal Processor, DSP, etc. capable of executing computer program code. The computer program code may be stored in a memory, MEM 13. The memory 13 can be any combination of a Read And write Memory, RAM, and a Read Only Memory, ROM. The memory 13 may also comprise persistent storage, which, for example, can be any single one or combination of magnetic memory, optical memory, or solid state memory or even remotely mounted memory.

The user equipment 10 further comprises a radio communication interface, 11. The radio communication interface 11 is adapted to communicate in a combined cell deployment and may comprise a first antenna port 11a and a second antenna port 11b.

According to one aspect of the disclosure the processing circuitry 12 comprises one or several of:
a pilot signal receiver module 121 configured receive at least two pilot signals transmitted from two different nodes of a combined cell in the wireless network,
a channel information determining module 122 configured to determine channel information for each received pilot signal, and
a feedback signal generator module 123 configured generate a feedback signal based on the channel information determined for each received pilot signal.

Although the description above contains many specifics, they should not be construed as limiting but as merely providing illustrations of some presently preferred example embodiments. The technology fully encompasses other embodiments which may become apparent to those skilled in the art. Reference to an element in the singular is not intended to mean “one and only one” unless explicitly so stated, but rather “one or more.” None of the above description should be read as implying that any particular element, step, range, or function is essential.

1. A method, performed in a network node, of scheduling resources for downlink transmissions to a user equipment, UE, in a heterogeneous wireless communication network including macro nodes and Low Power Nodes, LPNs, in a combined cell deployment, wherein each macro node shares a cell identity with one or more LPNs, the method comprising:
configuring two or more pilot signals for probing the UE, wherein each pilot signal is configured to be distinguishable from one or more other configured pilot signals;
sending a radio resource control, RRC, signal to the UE including information on the configuration of the two or more pilot signals;
controlling transmission of the two or more pilot signals, wherein transmission of one pilot signal is originated from the macro node and transmission of one or more further pilot signals is originated from respective one or more LPNs;
receiving a feedback signal, wherein the feedback signal is based on channel information obtained by the UE for each pilot signal; and
selecting one or more LPNs for downlink transmission based on the received feedback signal and UE specific information accessible in the network node.

2. The method in accordance with claim 1, further comprising:
initiating the selection of a downlink resource when a plurality of LPNs share a cell identity with a macro node.

3. The method in accordance with claim 1, further comprising:
initiating the selection of a downlink resource when presence of one or more UEs capable of combined cell deployment is detected in a macro cell.

4. The method in accordance with claim 3, further comprising:
selecting one of the one or more UEs capable of combined cell deployment present in the macro cell and performing the selection of downlink resources for the selected UE.

5. The method in accordance with claim 3, further comprising:
selecting each respective UE of the one or more UEs capable of combined cell deployment present in the macro cell and performing the selecting of downlink resources for each respective UE.

6. The method in accordance with claim 1, wherein the step of configuring two or more pilot signals comprises power scaling the two or more pilot signals so that the power ratio between a pilot signal of the macro node and a pilot signal of the LPN corresponds to a power ratio of a macro node power level and a LPN power level.

7. The method in accordance with claim 1, wherein the information on the configuration of the two or more pilot signals is included in an RRC configuration message.

8. The method in accordance with claim 1, wherein the two or more pilot signals are orthogonal.

9. The method in accordance with claim 1, wherein the two or more pilot signals are transmitted as S-CPICH signals with respective separate spreading codes.

10. The method in accordance with claim 1, wherein the feedback signal comprises signal quality measures.

11. The method in accordance with claim 9, wherein the signal quality measures are signal to interference noise ratio, SINR, values.

12. The method in accordance with claim 1, wherein the UE specific information accessible in the network node comprises the location of the UE.

13. The method in accordance with claim 10, wherein the selecting includes selecting a LPN having a SINR value superior to other SINR values representing other LPNs in the signal quality measures.

14. The method in accordance with claim 1, further comprising:
establishing a combined cell radio resource control, RRC, context for downlink transmission to the UE.

15. The method in accordance with claim 13, wherein establishing of the RRC context includes sending information to the selected LPN on the UE connection.

16. The method in accordance with claim 14, wherein the establishing of the RRC context further includes sending of scheduling information to the UE.

17. The method in accordance with claim 1, further including:
sharing information on LPNs not selected for the downlink transmission to the UE, providing for an improved resource utilization.

18. A network node for selecting downlink resources for downlink transmission to a user equipment, UE, in a heterogeneous wireless communication network including macro nodes and Low Power Nodes, LPNs, in a combined cell deployment, wherein each macro node shares a cell identity with one or more LPNs, the network node comprising:
a memory;
a processing unit configured to;
configure two or more pilot signals for probing the UE, wherein each pilot signal is configured to be distinguishable from one or more other configured pilot signals, and to control transmission of the two or more pilot signals from respective radio access nodes, wherein transmission of one pilot signal is originated from the macro node and transmission of one or more further pilot signals is originated from respective one or more LPNs by signaling over a node communication interface;
a radio communication interface configured to send a radio resource control, RRC, signal to the UE including information on the configuration of the two or more pilot signals and to receive a feedback signal from the UE, wherein the feedback signal is based on channel information obtained by the UE; and
wherein the processor is further configured to select one or more LPNs for downlink transmission based on received feedback signal and UE specific information accessible in the network node.

19. The network node of claim 18, wherein the network node is a NodeB of WCDMA/HSPA radio access technology, and further comprises radio communication circuitry for downlink transmission to a receiving UE.

20. A non-transitory computer program product,
comprising computer readable code which, when run in a network node causes the network node to perform the method according to claim 1.

21. A method in a user equipment, UE, for assisting selection of downlink resources for downlink transmission in a heterogeneous wireless communication network including macro nodes and Low Power Nodes, LPNs, in a combined cell deployment, wherein each macro node shares a cell identity with one or more LPNs, the method comprising:
receiving a radio resource control (RRC) signal including information on a respective configuration of two or more pilot signals;
receiving the two or more pilot signals;
processing the received two or more pilot signals to determine channel information for each pilot signal;
generating at least one feedback signal for the received pilot signals based on determined channel information; and
transmitting the at least one feedback signal to a receiving macro node.

22. The method according to claim 21, wherein the processing of the two or more pilot signals includes:
defining precoding vectors representing the number of pilot signals;
estimating a channel information matrix based on received pilot signals; and
computing a SINR value for each node from a combination of the precoding vectors and the channel matrix.

23. The method of claim 21, further including:
receiving scheduling information from a scheduling node in the wireless communication network.

24. A user equipment, UE, for selecting downlink resources for downlink transmission in a heterogeneous wireless communication network including macro nodes and Low Power Nodes, LPNs, in a combined cell deployment, wherein each macro node shares a cell identity with one or more LPNs, the UE comprising:
a memory 13;
a radio communication interface configured to receive downlink transmissions in the heterogeneous wireless communication network comprising a radio resource control, RRC, signal including information on a respective configuration of two or more pilot signals and the two or more pilot signals; and
a processing unit configured to process the received two or more pilot signals to determine channel information for each pilot signal and to generate at least one feedback signal for the received pilot signals based on determined channel information; wherein the radio communication interface is further configured to transmit the at least one feedback signal pilot signal to a receiving macro node.

25. A non-transitory computer program product, comprising computer readable code which, when run in a user equipment, UE, causes the UE to perform the method according to claim 21.
